(19) United States
(12) Patent Application Publication
(10) Pub. No.: US 2022/0186540 A1
(43) Pub. Date: Jun. 16, 2022

(54) INFINITE POWER DOOR CHECK MECHANISM AND METHOD OF OPERATION

(71) Applicant: Magna Closures Inc., Newmarket (CA)

(72) Inventors: Mario CAPPELLI, Newmarket (CA); Giovanni GENNAI, Newmarket (CA); Francesco CUMBO, Newmarket (CA)

(21) Appl. No.: 17/544,508

(22) Filed: Dec. 7, 2021

Related U.S. Application Data
(60) Provisional application No. 63/126,242, filed on Dec. 16, 2020.

(51) Int. Cl. E05F 5/02

(52) U.S. Cl. CPC E05F 5/025

(57) ABSTRACT

A system for controlling a motion of a door of a vehicle comprising: at least one user interface device comprising a control device, the control device being in operable communication with a door check mechanism configured for resisting the motion of the door relative to a vehicle body, wherein operation of the control device controls operation of the door check mechanism. The door check mechanism can comprise: a linkage coupled between a vehicle body and the door, the linkage configured to pivot about an axis; and a brake assembly coupled to the linkage for applying a resistive force to the linkage to resist rotation of the linkage about the axis.

### CROSS-REFERENCE TO RELATED APPLICATION

This application claims priority from the benefit of the filing date of U.S. Provisional Patent Application No. 63/126,242 filed on Dec. 16, 2020, entitled “INFINITE POWER DOOR CHECK MECHANISM AND METHOD OF OPERATION”, the contents of which are herein incorporated by reference.

### TECHNICAL FIELD

The present invention relates in general to actuation of vehicle door components.

### BACKGROUND

Current door check systems are used to stop movement of a door or to otherwise assist in door operation when the weight of the door undesirably affects movement of the door when the vehicle is inclined.

However, current state of the art solutions for door check systems can be problematic in view of packaging considerations, footprint, as well as operation in inclement situations (i.e. the undesirable influence of dirt and/or moisture) concerning consistency in performance. As such, there is a disadvantage of door check systems in that friction mechanisms can be exposed to environmental elements (e.g. water and dirt) and thus the generation of resistive forces is undesirably affected by environmental factors.

Another disadvantage to door check systems is that the resistive force generation function is not under the control of a vehicle user, and thus cannot be relied upon in all situations to provide the degree of resistive force needed by the user for different use applications of the vehicle.

### SUMMARY OF THE INVENTION

It is an object of the present invention to provide door check mechanism and operation thereof to obviate or mitigate at least one of the above presented disadvantages.

A first aspect provided is a door check mechanism for a door of a vehicle comprising: a linkage coupled between a vehicle body and the door, the linkage configured to pivot about an axis; and a brake assembly coupled to the linkage for applying a resistive force to the linkage to resist rotation of the linkage about the axis.

A second aspect provided is a door check mechanism for a door of a vehicle, comprising: a biasing member in operable connection with a linkage coupling the door to a vehicle body; a rotatable brake assembly coupled to the linkage, wherein a movement of the linkage causes a rotation of the rotatable brake assembly; and an actuator for controlling a biasing state of the biasing member, wherein a change in the biasing state of the biasing member varies a friction force applied by the rotatable brake assembly to the linkage for resisting the movement of the door.

A third aspect provided is a door check mechanism for a door of a vehicle comprising: a linkage coupled between a vehicle body and the door, the linkage configured to pivot about an axis; an actuator; and a brake assembly coupled to one of the door and the vehicle body, the brake assembly comprising a roller arrangement (64) for applying variable resistive force to the linkage to resist movement of the door relative to the vehicle body; wherein the roller arrangement is operable by operation of the actuator.

A fourth aspect provided is a system for controlling a motion of a door of a vehicle comprising: at least one user interface device comprising a control device, the control device being in operable communication with a door check mechanism configured for resisting the motion of the door relative to a vehicle body, wherein operation of the control device controls operation of the door check mechanism.

### BRIEF DESCRIPTION OF THE DRAWINGS

[0011]The non-limiting embodiments may be more fully appreciated by reference to the following detailed description of the non-limiting embodiments when taken in conjunction with the accompanying drawings, by example only, in which:

FIG. 1 shows a perspective view of a vehicle door assembly;

FIG. 2 is an example embodiment of control of the door check mechanism for the vehicle of FIG. 1;

FIG. 3 is a further example embodiment of control of the door check mechanism for the vehicle of FIG. 1;

FIG. 4 is a further example embodiment of control of the door check mechanism for the vehicle of FIG. 1;

FIG. 5 is a further example embodiment of control of the door check mechanism for the vehicle of FIG. 1;

FIG. 6 is an example embodiment of the door check mechanism of FIGS. 2,3,4 and 5 in an open position;

FIG. 7 is an example embodiment of the door check mechanism of FIG. 6 in a closed position;

FIG. 8 is a cross sectional view of the door check mechanism of FIG. 6;

FIG. 9 is a perspective view of the door check mechanism of FIG. 6 showing external details;

FIG. 10 is a perspective view of the door check mechanism of FIG. 6 showing internal details;

FIGS. 11, 12, 13a, 13b show a further example embodiment of the door check mechanism of FIGS. 2,3,4 and 5;

FIGS. 14, 15a, 15b, 16a, 16b show a still further example embodiment of the door check mechanism of FIGS. 2,3,4 and 5;

FIG. 17 is an example operation of the door check mechanism of FIGS. 2,3,4 and 5;

FIG. 18 is a further example embodiment of the door check mechanism of FIGS. 2,3,4 and 5 in a closed position; and

FIG. 19 is a further example embodiment of the door check mechanism of FIGS. 2,3,4 and 5 in an open position.

### DETAILED DESCRIPTION

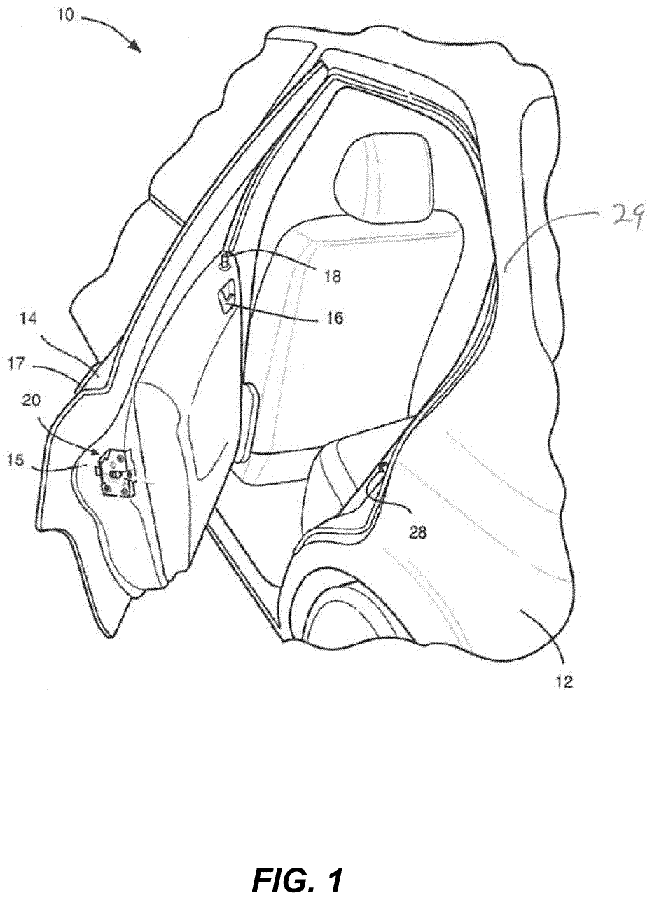

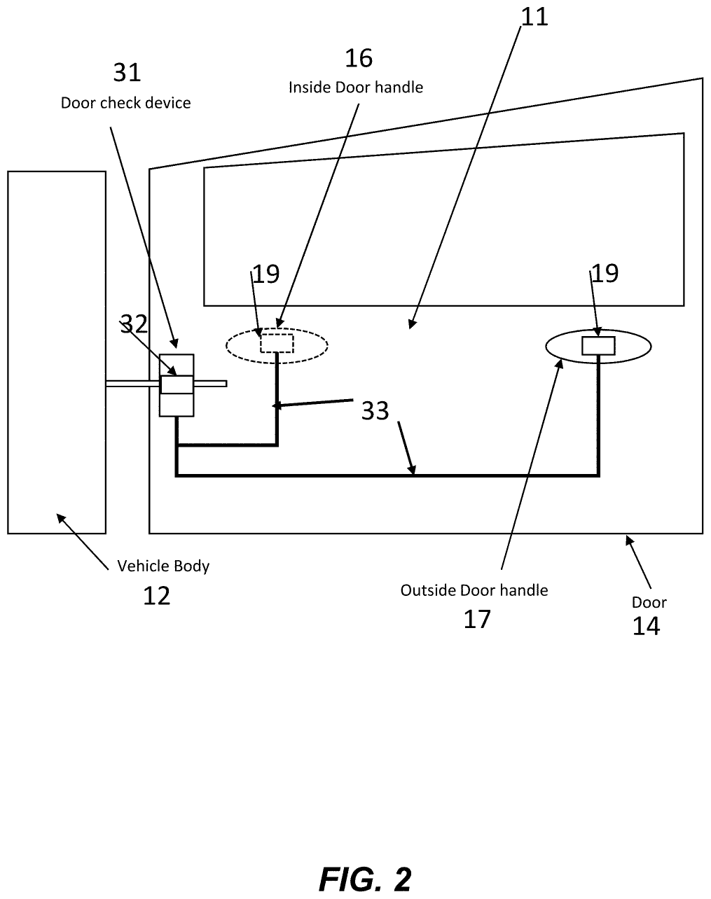

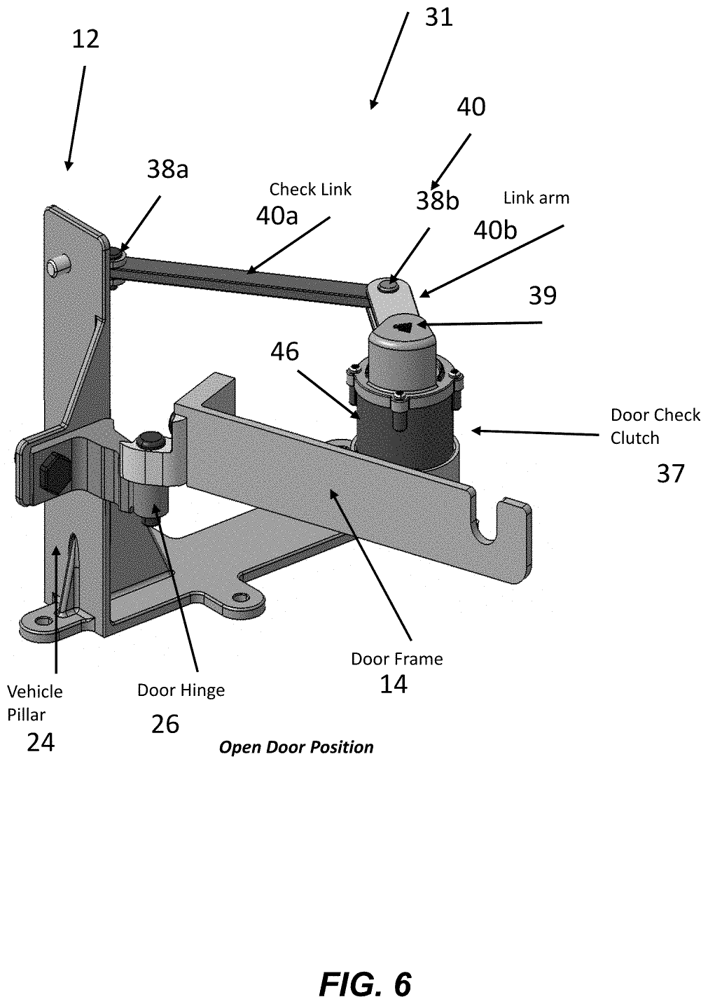

Referring now to the drawings and the illustrative embodiments depicted therein, as depicted by example in FIGS. 1 and 6, a door check mechanism 31 is mountable to a door 14 of a vehicle 10. The door check mechanism 31 is a mechanical system that is used to increase/decrease resistance to door 14 motion during movement or to otherwise hold the door 14 is selected (e.g. intermediate) positions. FIG. 1 is a perspective view of the vehicle 10 that includes a vehicle body 12 and at least one vehicle door 14 (also referred to as closure panel 14). The vehicle door 14 includes a latch assembly 20 that is positioned on an edge face 15 and which is releasably engageable with a striker 28 on the vehicle body 12 to releasably hold the vehicle door 14 in a closed position. An outside door handle 17 and an inside door handle 16 can be provided for opening the latch assembly 20 (i.e. for releasing the latch assembly 20 from the striker 28) to open the vehicle door 14. An optional lock knob 18 is shown and provides a visual indication of the lock state of the latch assembly 20 and may be operable to change the lock state between an unlocked position and a locked position. It is recognized that the closure panel 14 is positioned adjacent to pillar 29 when closed, such that a hand of the vehicle user (e.g. driver) is inhibited from insertion between the pillar 29 and the closure panel 14. It is recognized that the latch assembly 20 can be configured as any type of latch (e.g. manual release, power release, with or without cinch functionality, etc.). Operation of the latch assembly 20 can be coupled to operation of the door check mechanism 31, as further described below. Further, the door check mechanism 31 can have an actuator (e.g. electric motor 34—see FIG. 2) to vary a level of friction generated by the door check mechanism 31, which is used to moderate the opening and closing of the door 14.

The closure panel 14 (e.g. occupant ingress or egress controlling panels such as but not limited to vehicle doors and lift gates/hatches) is connected to the vehicle body 12 via one or more hinges 26 (e.g. mounted on a pillar 24) and the latch assembly 20 is for retaining the closure panel 14 in a closed position once closed. It is also recognized that the hinge 26 can be configured as a biased hinge 26 that can be configured to bias the closure panel 14 towards the open position and/or towards the closed position. In terms of a biased hinge 26 used in combination with the latch assembly, the biased hinge can provide for assistance in presenting the closure panel 14 beyond where a ratchet of the latch assembly 20 can influence positioning of the closure panel 14. It is also recognized that the biased hinge 26 can be configured to assist operation of the door check mechanism 31 is actuating/assisting the opening and closing of the closure panel 14. The closure panel 14 has the mating latch component 28 (e.g. striker) mounted thereon for coupling with a respective latch assembly 20 (e.g. with the ratchet component of the latch assembly 20) mounted on the vehicle body 12. Alternatively, the latch assembly 20 can be mounted on the body 12 and the mating latch component 28 can be mounted on the closure panel 14.

Referring to FIG. 2, an example check mechanism control system 11 is shown, such that each door handle 16,17 can have a switch 19 for controlling the actuator 32 of the door check mechanism 31, as further described below. The switches 19 are electrically coupled to the actuator 32 by way of electrical connections 33.

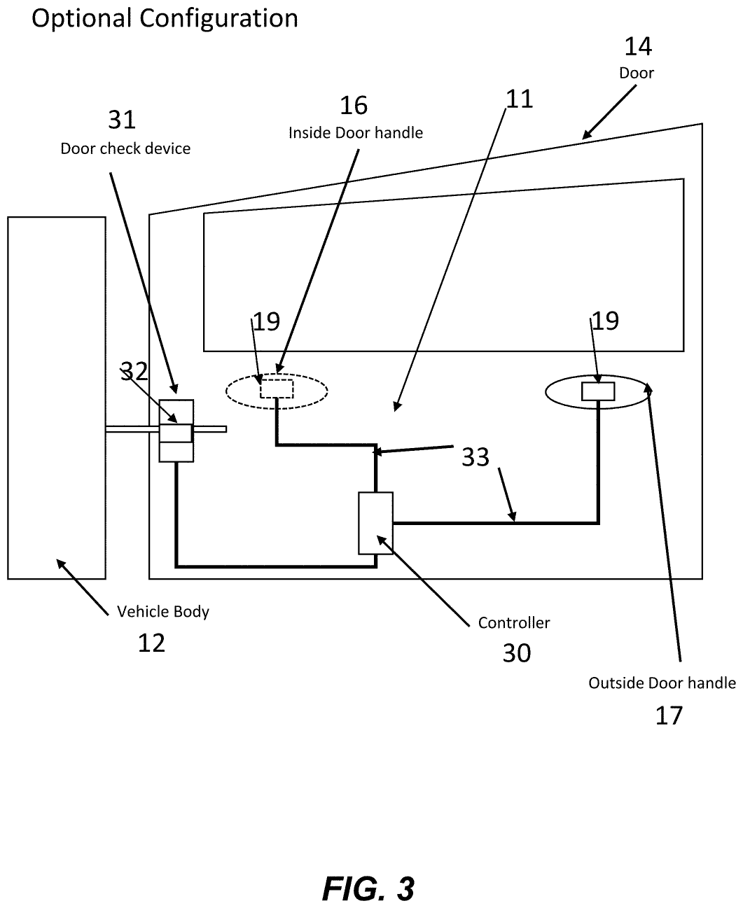

Referring to FIG. 3, shown is an alternative embodiment of the check mechanism control system 11, such that a controller 30 (e.g. Body Control Module BCM) can be coupled between the handles 16,17 and the door check mechanism 31.

In this embodiment, the switches 19 supply electronic signals to the controller 30, which in turn supplies actuation signals to control the operation of the actuator 32.

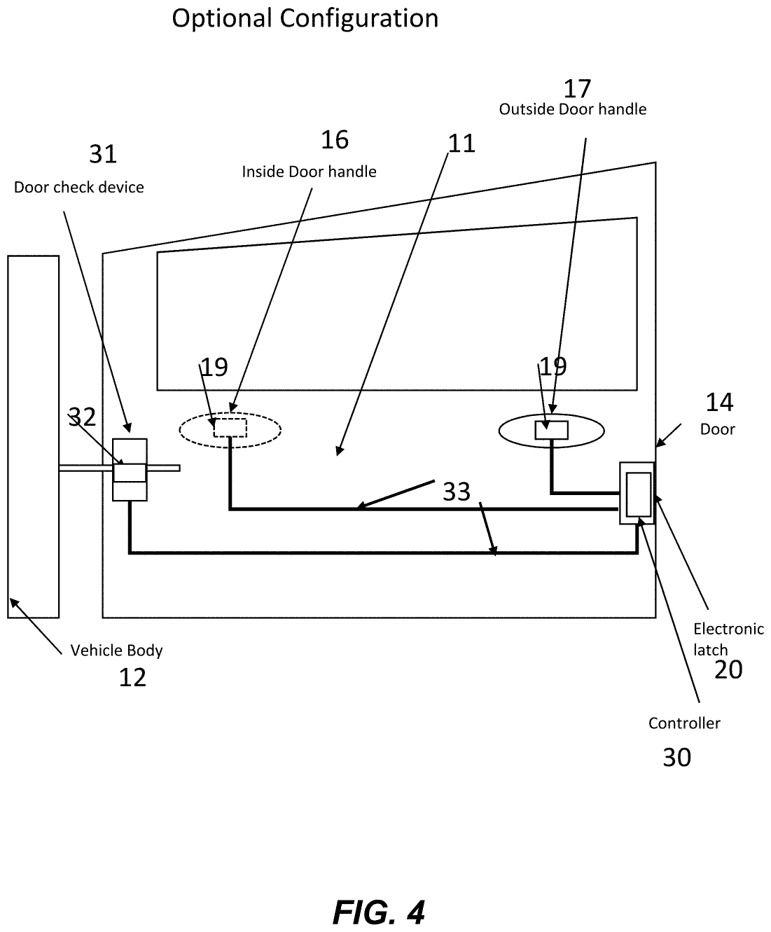

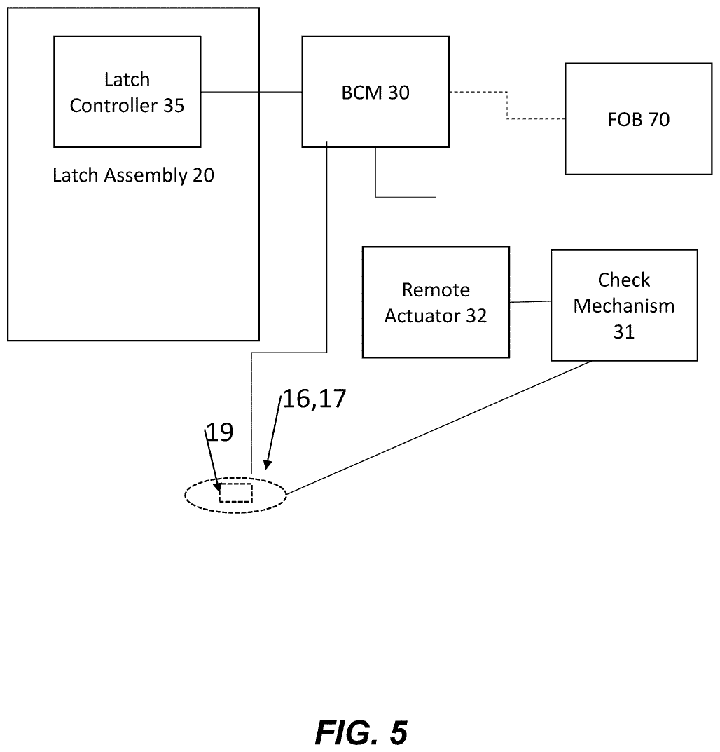

Referring to FIG. 4, shown is a further alternative embodiment of the check mechanism control system 11, such that a controller 30 (e.g. latch controller) can be coupled between the handles 16,17 and the door check mechanism 31. In this embodiment, the switches 19 supply electronic signals to the controller 30, which in turn supplies actuation signals to control the operation of the actuator 32. Further, the controller 30 can be housed in the latch 20 (e.g. an electronic latch) and as such the controller can be used to coordinate the operation of the latch 20 with the door check mechanism 31, as the door 14 is opened and closed. Also shown in FIG. 5, an example configuration utilizing a BCM 30, a latch controller 35 and a FOB 70, to facilitate remote actuation of the door check mechanism 31 via the FOB 70. For example, the FOB 70 can be used to activate the switch(es) 19 in the handle(s) 16,17

Accordingly, as shown by example in FIGS. 2, 3, 4, 5 the check mechanism control system 11 can control the motion of the door 14 by utilizing at least one user interface device (e.g. a door handle 16,17) each comprising a control device (e.g. a switch 19), each control device 19 being in operable communication with the door check mechanism 31 (e.g. via an optional controller 30), such that operation of the door check mechanism 31 facilitates resisting the motion of the door 14 relative to the vehicle body 12, wherein operation of the control device controls the door check device. In this manner, the door check mechanism 31 can be used to slow down the pivoting of the door 14 about the hinges 26 or otherwise arrest the pivotal motion of the door 14 and thus retain the door 14 in a fixed intermediate position between the open and close (e.g. locked) positions of the door 14. In other words, the control system 11 can be used to trigger the door check mechanism 31 (e.g. via operation of the actuator 32) to release or block movement of the door 14 (as connected via one or more links 40—see FIG. 6 by example). It is also recognized that the operation of the actuator 32 could be used by the door check mechanism 31 to infinitely vary a level of friction generated by the door check mechanism 31, as further described below, recognizing that an increase in generated friction could be used to further slow or otherwise stop motion of the door 14 while a decrease in friction could be used to speed up or otherwise enable motion of the door 14.

[0033]As such, in view of FIGS. 2,3,4,5, the switch(es) 19 of the handle(s) 16,17 can be used to control the door check mechanism 31, such that manual control of the door check via operation of the handle(s) 16,17 (and or FOB 70) can be used to stop the door 14 in any intermediate open/close position desired by the operator (e.g. by actuating or releasing the handle 16,17 as configured). For example, operation of the handle9s) 16,17 (and/or FOB) could be used to apply and/or release the door check mechanism 31 (for example, to release the door check and thus allow the door 14 to be operated by the user manually while the friction generated between the surfaces 41,43 is decreased/disabled.

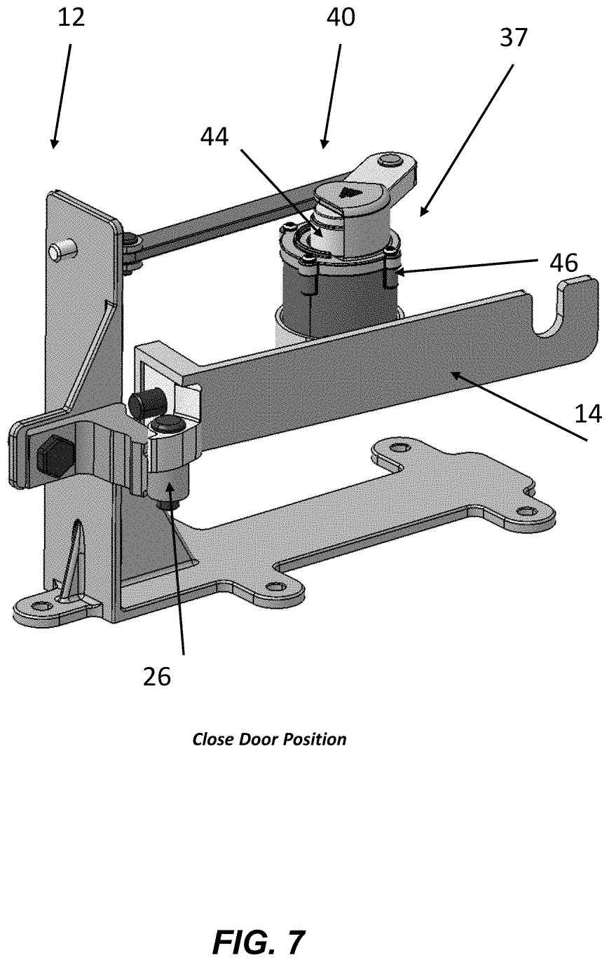

Referring to FIGS. 6, 7, 8, 9, 10, shown is an example door check mechanism 31 using an adjustable biasing member 42 (e.g. a wrap or coil spring) to vary the door 14 check force applied on a linkage 40 (e.g. one or more links 40 such as a check link 40a and a link arm 40b). The linkage 40 can be connected to the vehicle body 12 by a first pivot connection 38a and to the door check mechanism 31 (e.g. to a friction body 44) by a connection 39. In the example of multiple links 40a,b, the links 40a,b can be interconnected by second pivot connection/(s) 38b.

Firstly the new door check mechanism 31 is advantageously for resisting rotation of the linkage 40 coupling the door 14 to the vehicle body 12, not for resisting a sliding motion between the door 14 and the linkage 40 as is known in the art. The biasing member 42 (e.g. wrap spring) is operated by opening or constricting a diameter of the biasing member 42, such that the biasing member 42 is positioned about and in contact with the friction body 44 (e.g. a drum 44), such that as the diameter of the biasing member is reduced, friction generated between the friction body 44 and the biasing member 42 is increased. Conversely, as the diameter of the biasing member is increased, friction generated between the friction body 44 and the biasing member 42 is decreased. The combination of the biasing member 42 and the friction body 44 (i.e. their interaction there between as moderated by operation of a guide member 49) can be referred to as a brake (e.g. clutch) assembly 37, which is coupled to the linkage 40 for applying a resistive force to the linkage 40 to resist rotation of the linkage 40 about a pivot axis 48.

The friction body 44 is mounted to a housing 46 on a pivot axis 48. The housing 46 is mounted to the door 14. The biasing member 42 is also mounted to the housing 46, such that during movement of the linkage 40 (i.e. as the door 14 is moved between the open and closed positions), a friction surface 43 of the body 44 moves relative to an adjacent surface 41 of the biasing element 42. Then the surfaces 41,43 are in contact, friction is generated during relative movement between the body 44 and the biasing element 42. It is recognized that as the diameter of the biasing element is varied (due to operation of the actuator 32), the degree/level of friction generated between the surfaces 41,43 is also varied. For higher rates of friction, the door check mechanism 31 can be used to arrest movement of the door 14 (e.g. facilitate one or more intermediate hold positions). For example, one can think of the locking effect used on a weightlifting bar you squeeze to unlock to remove plates from the bar.

Referring again to FIG. 8, the door check mechanism 31 can also have a cover 47 for the housing 46, as well as a member guide 49 for facilitating the increasing/decreasing of the diameter of the biasing element 42, as further described below. The member guide 49 can be mounted on the axis 48, configured for axial displacement D along the axis 48. Further, the friction body 44 is configured for rotation R about the axis 48, as moved by the linkage 40. The actuator 32 is fixed to the housing 46 as well as to a coupling 50 (e.g. threaded members 50 such as a nut and screw arrangement). The coupling 50 is also connected to the member guide 49, such that when the coupling 50 is turned via operation of the actuator 32 the member guide 49 is moved axially along the axis 48, in order to increase/decrease the diameter of the biasing element 42 (to adjust the degree of generated friction during relative movement between the friction body 44 and the biasing member 42). Further, the door check mechanism 31 can have a secondary axial biasing member 47, which can override the door check in case of motor or power failure and thus loosen the biasing member 42 by expanding the diameter via movement of the leg(s) 42a by moving the member guide 49 under influence of the secondary axial biasing member 47. Alternatively, in an emergency or power failure situation, the door check mechanism 31 can have the secondary axial biasing member 47, which can override the door check and thus tighten the biasing member 42 by reducing the diameter via movement of the leg(s) 42a by moving the member guide 49 under influence of the secondary axial biasing member 47.

It is recognized that the actuator 32 and coupling 50 can also be configured to move linearly, such that the member guide 49 is moved axially along the axis 48 in order to increase/decrease the diameter of the biasing element 42 (to adjust the degree of generated friction during relative movement between the friction body 44 and the biasing member 42). It is also recognized that the actuator 32 and coupling 50 can cooperate to rotate the member guide 49 about the axis 48, in order to increase/decrease the diameter of the biasing element 42 (to adjust the degree of generated friction during relative movement between the friction body 44 and the biasing member 42.

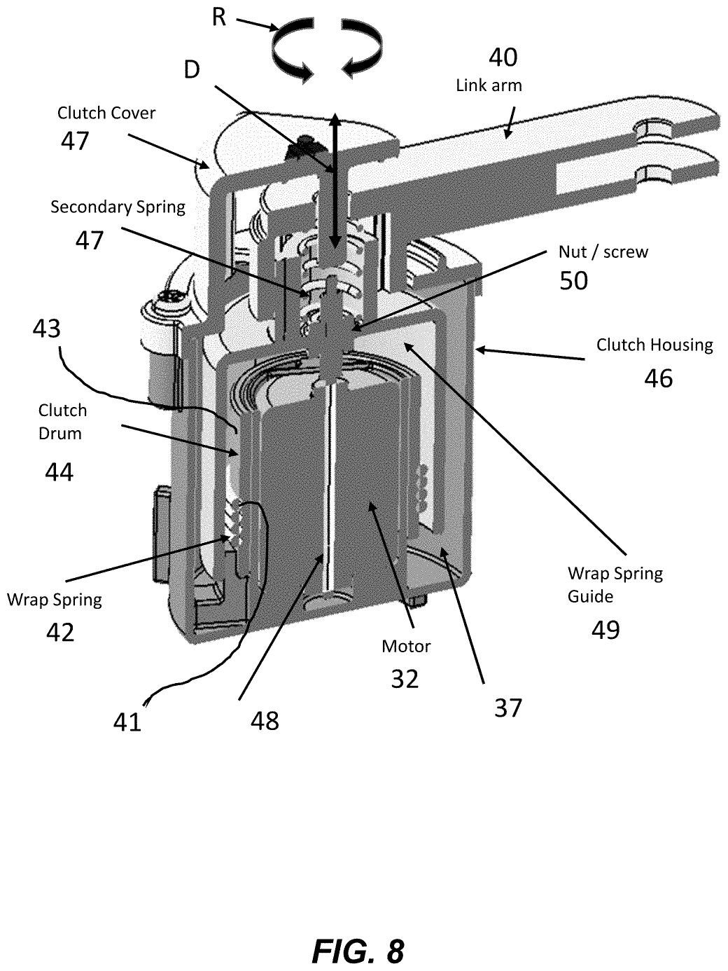

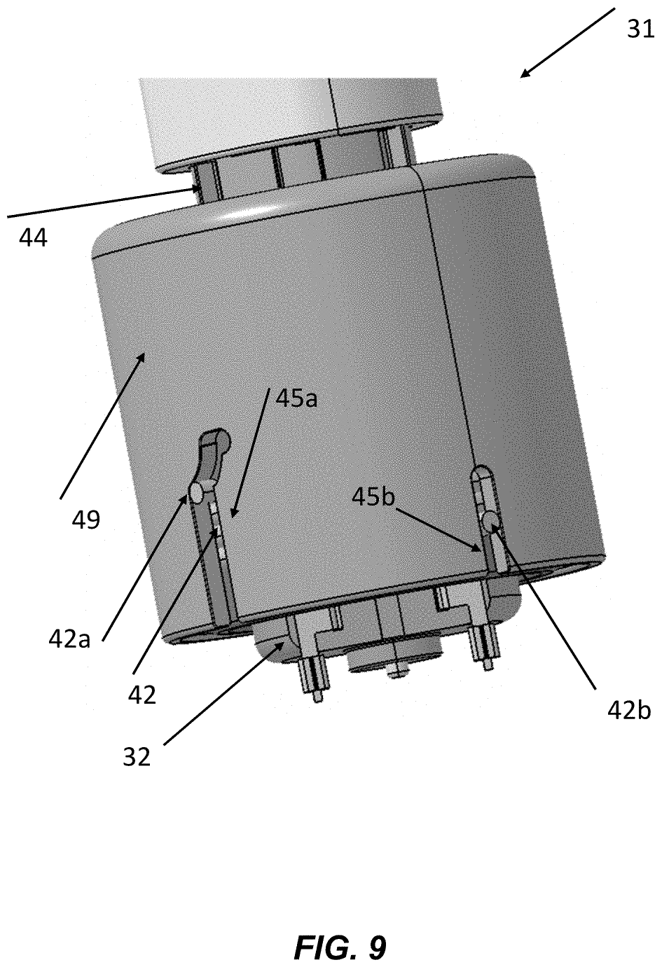

As shown in FIGS. 8 and 9, the example embodiment is shown by which the member guide 49 is displaced via operation of the coupling 50 (between the actuator 32 and the member guide 49) to displace D the member guide 49 axially (for example) with respect to the axis 48. For example, the coupling 50 has a screw and nut arrangement, whereby the screw is connected to the actuator 32 and the nut is connected to the member guide 49. During rotation of the screw by the actuator 32, the nut is displaced along the axis 48 and as such causes connected member guide 49 to also displace D along the axis 48, in order to increase or decrease the diameter of the biasing member 42 (based on the direction of travel of the nut).

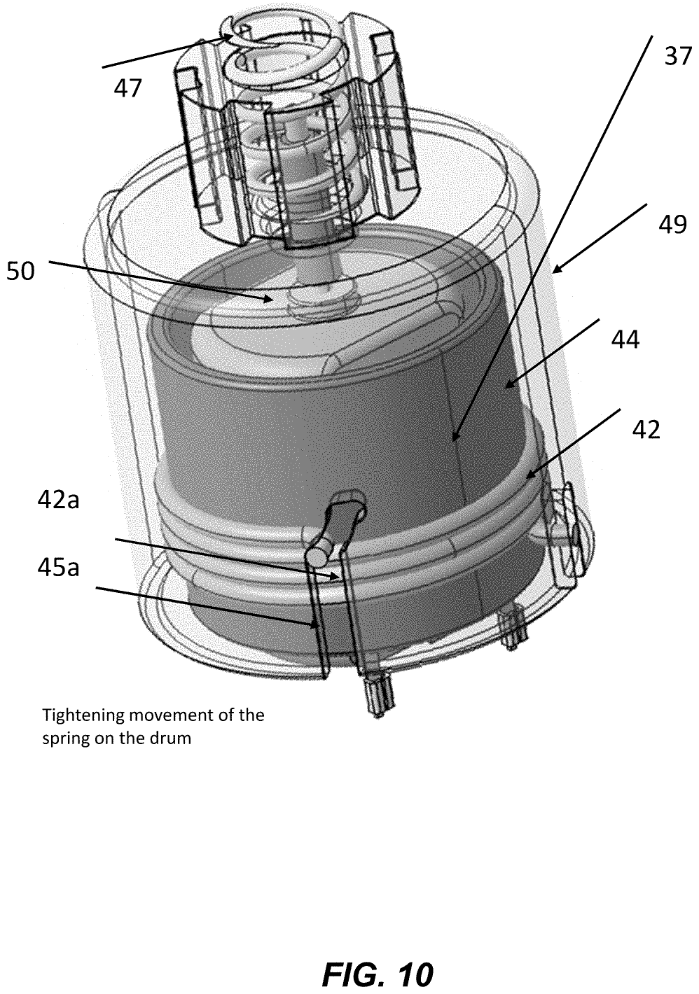

Referring to FIG. 9, legs 42a,b of the biasing member 42 are positioned in corresponding slots 45a,b in the member guide 49, such that displacement D of the member guide 49 causes movement of the leg(s) 42a,b in their slot(s) 45a,b. It is recognized that movement of the leg(s) 42a,b in their slot(s) 45a,b causes the diameter of the biasing member 42 to increase/decrease and thus vary the friction generated between the surfaces 41,43 (see FIG. 8). For example, slot 45a can have a lobe 47 extending at an angle to the axis 48, such that travel of the leg 42a in the lobe 47 causes the biasing member 42 to either increase or decrease in diameter. In other words, movement of the member guide 49 relative to the biasing member 42 causes variation in the friction generated between the surfaces 41, 43. FIG. 10 shows a perspective view of the check door mechanism 31.

As discussed above, it is recognized that the movement of the member guide 49 (as influenced by the actuator 32 and coupling 50) can be rotational and/ or axial with respect to the axis 48, as desired, such that the movement of the member guide 49 causes variation in the friction between the surfaces 41, 43 (e.g. cause a respective loosening or tightening of the biasing member 42 about the friction body 44).

In terms of the friction body 44/biasing member 42 combination, it is advantageous using, for example, a wrap spring 42 vs. applying a brake pad against the wrap spring guide 49, as the surface of the friction body 44 is protected in the housing 46 and thus can be better maintained in operating conditions (e.g. inhibiting exposure to contaminants such as dirt/moisture) so friction generated can be more consistent. Further, undesirable a brake pad has to be pushed with high force to achieve the required friction and therefore use of the brake pad would need a corresponding sized motor and/or gearing ratio or leverage with increased efficiency, thus requiring many more and larger/stronger components that what are used in the door check mechanism 31 described herein.

Other advantages of the biasing member 42/friction body 44 arrangement can include: the wrap spring 42 is normally auto locking when tightened or could have a friction in reverse rotation, and if the actuator 32 is a step motor one can set the level of friction to stop the friction body rotation (and thus arrest the door 14) in an intermediate axial position along the axis 4; movement of the leg(s) 42a,b can work in 2 ways, for example one can have a tightened spring 42 in a rest position or a free spring 42 in rest position, depending on the safety requirements and if the door 14 is powered or manual; and during a loss of power condition one can close the door 14 by configuring the door check mechanism 31 operation, such that in the closing direction it could work only with friction due to spring 42 compression (e.g. reduction in diameter), however rotation of the spring 42 (due to movement of the member guide 49) can be set to open the spring 42 itself.

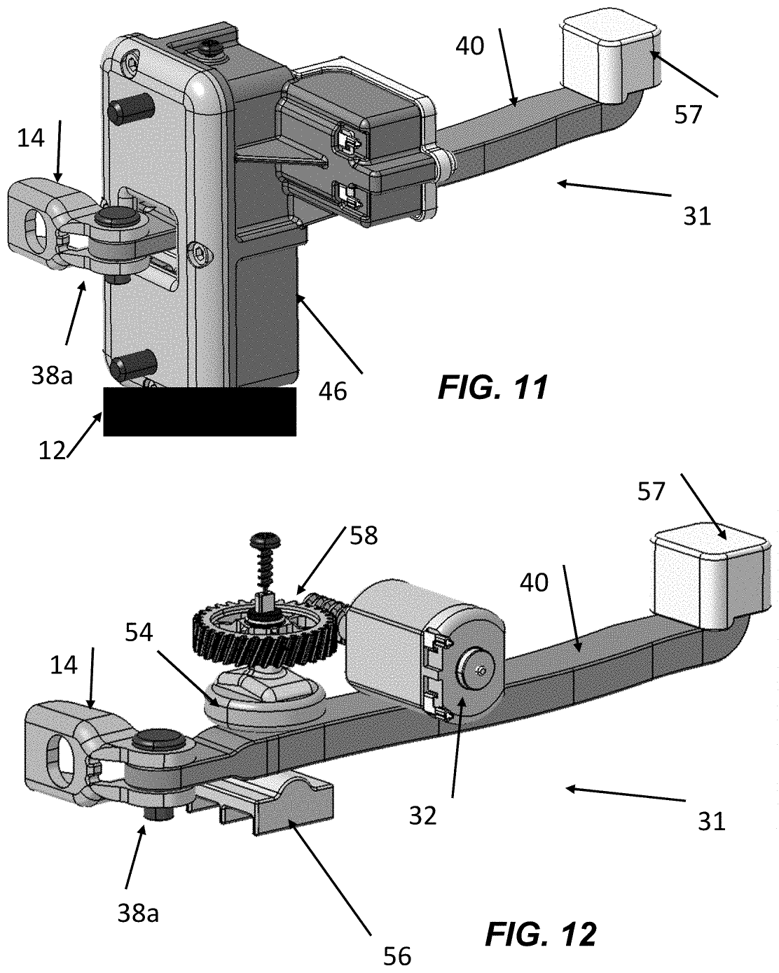

Referring to FIGS. 11, 12, 13a, 13b, shown is an alternative embodiment of the door check mechanism 31 of FIG. 2, such the door check mechanism 31 operation is configured to utilize a breaking principle based on a variable ball 50 constraint that forces the ball 50 between a pair of tilted planes 52. For example, the actuator 32 is connected to a box 54 containing the ball 50 and the tilted planes 52 (for example the ball box 54 that has two different tilted planes 52 configured like a simple house roof). The ball box 54 can be situated inside of the housing 46, which can be mounted to the vehicle body 12. The door check mechanism 31 has a linkage 40 connected at one end by pivot connection 38a to the door 14, for example. The linkage 40 is also supported by a support 56 (e.g. a bearing surface) on one side and has contact with the ball 50 on the other side. The actuator 32 can be coupled to the ball box 50 by a gear arrangement 58, such that operation of the actuator 32 causes rotation of the gear arrangement 58 and thus affects positioning of the tilted planes 52 with respect to the ball 50. At another end of the linkage 40 is a stop 57, which inhibits movement of the ball 50 past the end of the linkage 40 and thus acts as a stop for opening of the door 14.

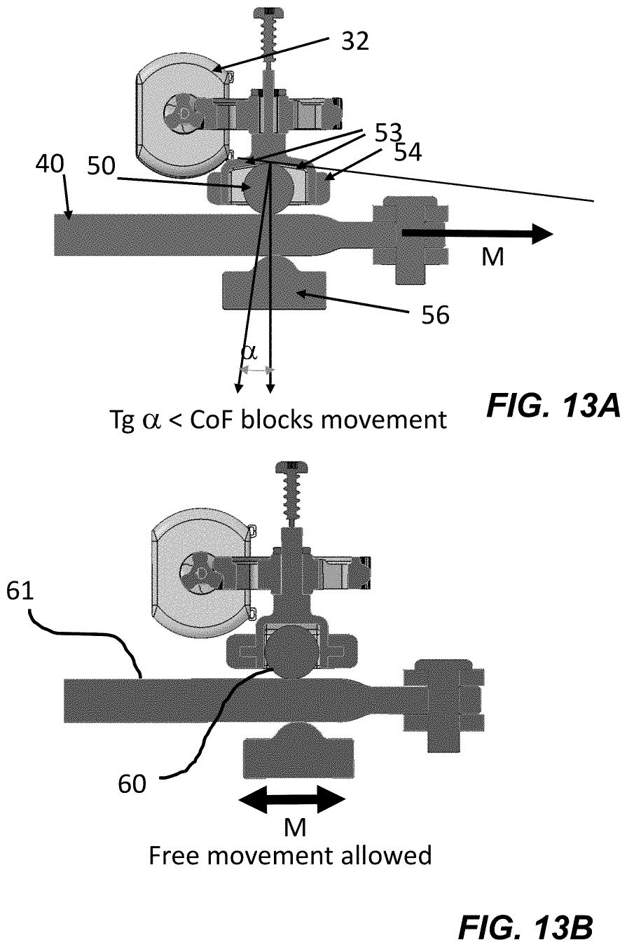

In terms of operation, when the ball 50 is exposed to the tilted planes 53, friction generated between surface 60 (of the ball 50) and surface 61 (of the linkage 40) is increased, thus inhibiting relative displacement between the housing 46 (e.g. connected to the vehicle body 12) and the linkage 40 (e.g. connected to the door 14). In this manner, the door check operation is provided. It is recognized that the movement of the ball box 54 can be configured, such that positioning at one extreme (e.g. as shown in FIG. 13a) would effectively restrict (e.g. lock) movement of the housing 46 along the linkage 40, while positioning at another extreme (e.g. as shown in FIG. 13b) would effectively unhinder (e.g. unlock) movement of the housing 46 along the linkage 40.

For example, as shown in FIG. 13a, the ball 50 is constrained by the tilted planes 53 and thus rotation of the ball 50 is inhibited thereby, thereby increasing the friction generated (e.g. changing the friction generated between the surfaces 60,61 from rolling friction to sliding friction). When the ball 50 rotation within the ball box 54 is unhindered, as shown in FIG. 13b by removal of the tilted planes 53 against the surface 60, free(r) relative movement M is facilitated between the housing 46 and the linkage 40. It is recognized that operation of the actuator 32 causes rotation of the ball box 54 and thus changes in orientation of the tilted planes 53 with respect to the surface 60 of the ball 50 (e.g. between positions shown by example of FIGS. 13a,b)

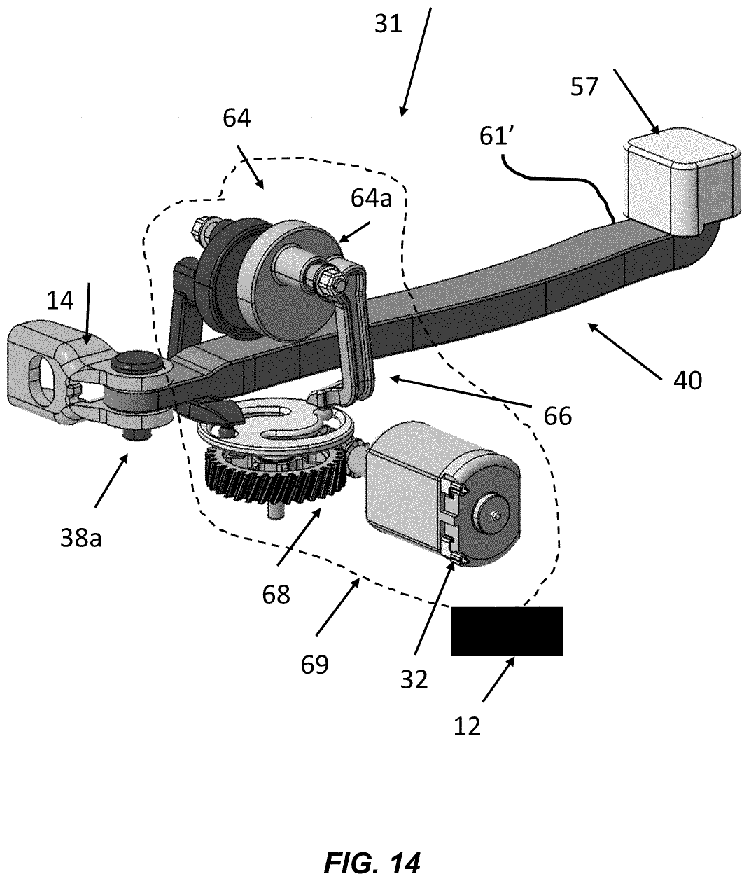

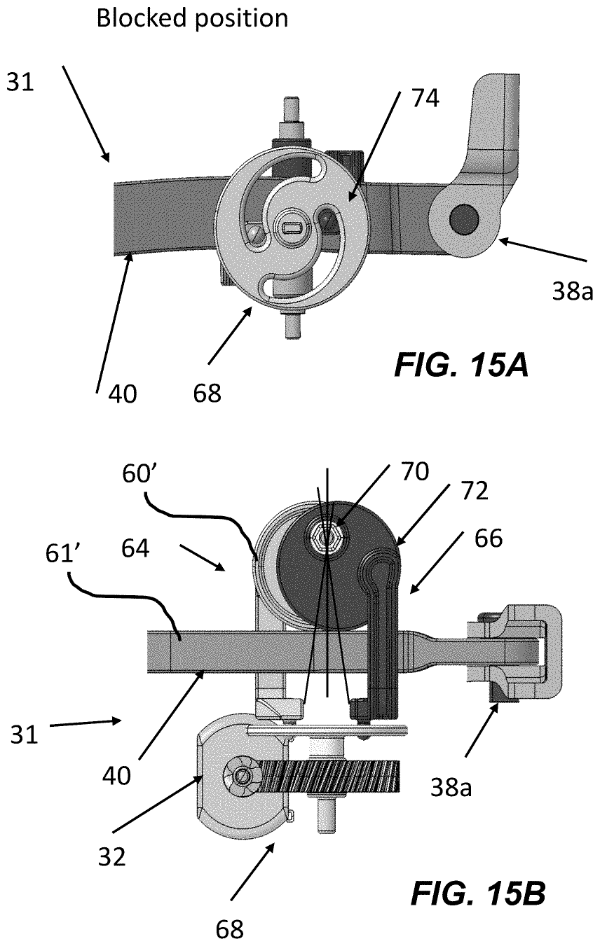

Referring to FIGS. 14, 15a,b, 16a,b, a further embodiment of the door check mechanism 31 is using a roller (a cam or ball bearing type) arrangement 64 for locking with the linkage 40 when the roller (cam or bearing) arrangement 64 is rolled into a locking position (as shown in FIGS. 15a,b).

Referring to FIG. 14, the door check mechanism 31 has the roller arrangement 64 positioned adjacent to the surface 61′ of the linkage 40, such roller(s) 64a,b can be placed into or out of engagement with the surface 61′ via operation of the actuator 32. The actuator 32 is coupled to the roller arrangement 64 by a pair of arms 66 connected to a gearing arrangement 68. A housing 69 (shown in dotted line for ease of illustration) can enclose the actuator 32, the roller arrangement 64, the gearing arrangement 68 and the pair of arms 66, for example, such that the housing 69 can be mounted on the vehicle body 12.

Referring to FIGS. 15a,b, the roller arrangement 64 has a pair of rollers 64a,b (e.g. cams) mounted on an eccentrically positioned axis of rotation 70. During operation of the actuator 32, the gear arrangement 68 positions/pulls the pair of arms 66, thus rotating the rollers 64a,b about the axis 70 and thus into contact with the surface 61′ (i.e. a surface 60′ of the rollers 64a,b engages the surface 61′). Is is recognized that the degree to which (i.e. the force) that the arms 66 apply the rollers 64a,b against the linkage 40 can affect the degree of friction generated between the surfaces 60′, 61′. As shown, the arms 66 can be coupled at one end by a pivot connection 72 to the roller arrangement 64 and at another end by a pin and slot connection 74 to the gear arrangement 68.

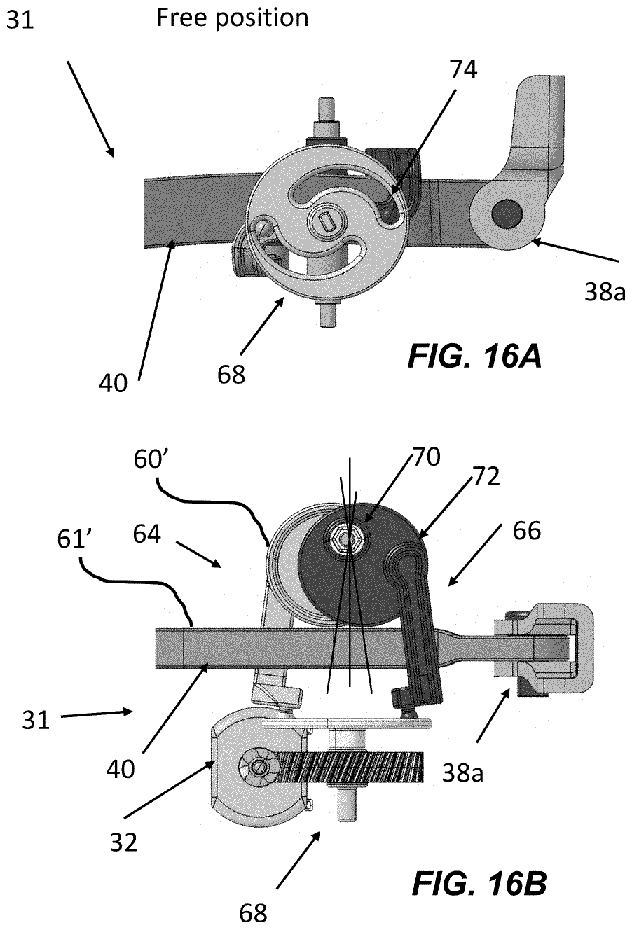

FIGS. 16a,b shows the roller arrangement 64 out of engagement with the linkage 40, as dictated by operation of the actuator 32 via the gear arrangement 68. As such, in view of the FIGS. 14, 15a,b, 16a,b, the cam principle of the roller arrangement 64 is based on a blocking action from roller(s) 64a,b that can loosen/tighten tighten or otherwise free/restrict (either absolutely or in varying degrees of applied friction) the relative movement between the housing 46 and the linkage 40 of the door check mechanism 31. For example, the motor 32 turns a slotted disk (of the gear arrangement 68) and a spiral shape of slots in the slotted disk rotates the roller(s) 64a,b and thus either towards or away from the linkage 40.

An advantage of the door check mechanism 31 of FIGS. 14, 15a,b, 16a,b is that compared to a brake pad type mechanism, the motor 32 is only used (rotating the roller arrangement 64 with a very low moment for small precession arm) to move the roller arrangement 64 and not actually have to control the amount of pressure applied by a friction pad to a linkage. For example, the roller arrangement 64 configuration may not just change the contact area of the cam from small to large for locking, rather it can cause a compression of the roller arrangement 64 with the linkage 40 (and due to the door linkage 40 moving relatively with respect to the roller arrangement 64) can cause a locking or squeezing action on the linkage 40, as one of the rollers 64a,b can be self locking.

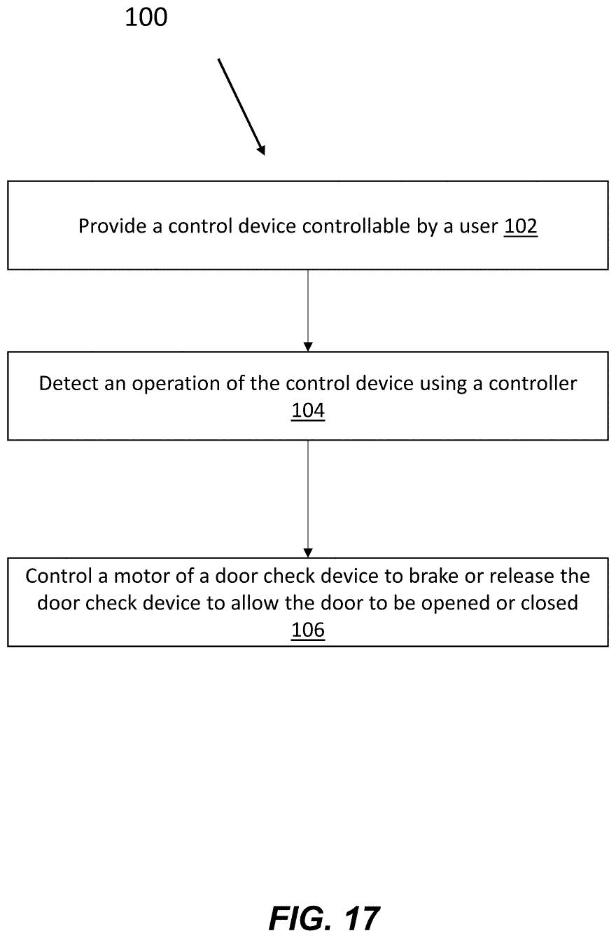

Referring to FIG. 17, shown is an example operation 100 of the door check mechanism 31. At step 102, a control device (e.g. a switch 19 of a door handle 16,17) is provided for use by a user in affecting a degree of friction generated by the door check mechanism 31. At step 104, a controller 30 detects a signal generated by operation of the control device. At step 106, based on the signal, the controller controls an actuator 32 of the door check mechanism 31 in order to vary the degree of friction. It is recognized that depending upon the degree of friction generated (as controlled by the controller 30), degree of friction generated facilitates to brake or to release the door check mechanism 31 in order to affect the open/ close positioning of the door 14.

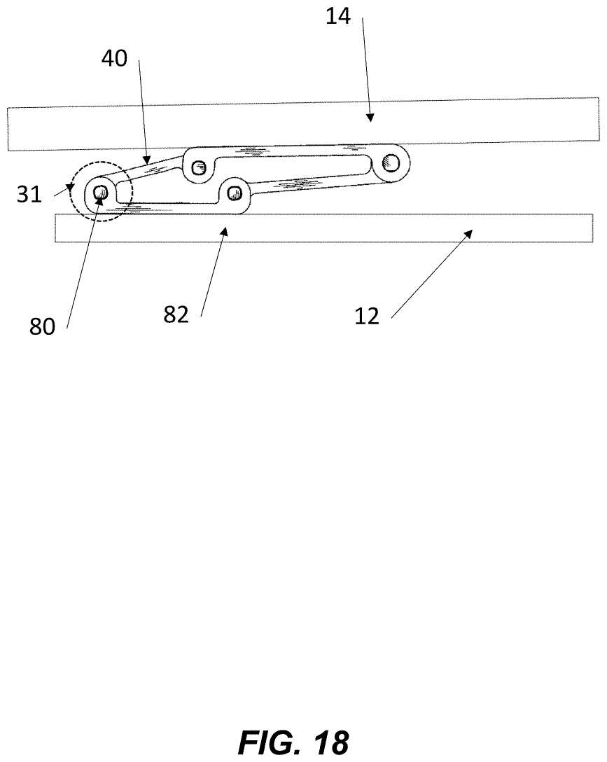

Referring to FIG. 18, shown is a further embodiment of the door check mechanism 31 (shown in ghosted view), provided as part of a multibar linkage 82, for example as having the linkage 40 (e.g. link arm 40b—see FIG. 6, or link arm 40 see FIG. 8) as one of the linkages of the multibar linkage 82, such that the door check mechanism 31 is connected to a pivot 80 of the multibar linkage 82. For example, referring to FIG. 8, the pivot 80 can be situated on the pivot axis 48 of the door check mechanism 31. As such, since the door check mechanism 31 rotates about an axis, the door check mechanism 31 could be coupled to a multibar linkage 82 to apply a door check force directly to the multibar linkage 82 of the door 14, e.g. on one of the linkages 40 of a multi-bar linkage 82 system.

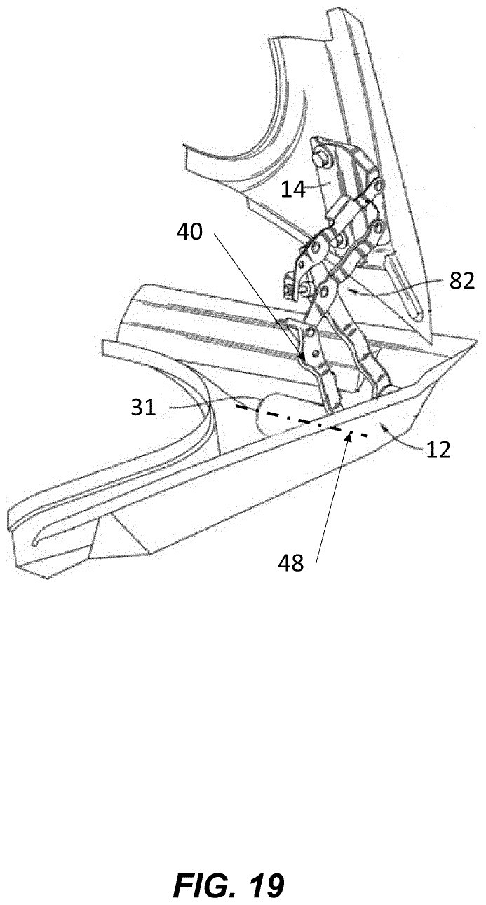

Referring to FIG. 19, shown is a further embodiment of the door check mechanism 31. Similarly, it could be connected axially with one of the pivots 80 along the pivot axis of a linkage for a hood 14, or a frunk 14 to hold the frunk open. As such, the door check mechanism 31 can be acting on the driven linkage (e.g. linkage 40 of the multibar linkage 82.

The embodiments described herein may also be applied to a tail gate retention system operating in parallel to with a powered counterbalance for replacing friction system and/or springs and gas devices, such that only a powered lead screw and motor may be provided in the spindle reducing the weight of the spindle and other efficiencies. The embodiments described herein may also be applied to a powered window regulator system and replace a braking system as a non-backdrivable gearing of the powered window regulator. In yet another application, the embodiments described herein may be applied to a parking brake system.

I claim:

1. A door check mechanism (31) for a door (14) of a vehicle (10) comprising:
a linkage (40) coupled between a vehicle body (12) and the door, the linkage configured to pivot about an axis (48); and
a brake assembly (37) coupled to the linkage for applying a resistive force to the linkage to resist rotation of the linkage about the axis.

2. The mechanism of claim 1, wherein the brake assembly further comprises a friction body (44) and a biasing member (42) positioned adjacent to the friction body, such that contact between a first surface (43) of the friction body and a second surface (41) of the biasing member generates friction of the resistive force to provide for said resist rotation.

3. The mechanism of claim 2 further comprising a member guide (49) coupled to the biasing member and to an actuator (32), such that operation of the actuator displaces the member guide relative to the biasing member in order to vary the friction generated between the first surface and the second surface.

4. The mechanism of claim 3, wherein the displacement of the member guide either increases or decreases a diameter of the biasing member.

5. The mechanism of claim 3 further comprising the biasing member connected to the member guide by at least one leg (42a) of the biasing member positioned in a corresponding slot (45a) of the member guide.

6. The mechanism of claim 2, wherein the linkage 40 comprises a first link (40a) and a second link (40b), such that the first link and the second link are coupled to one another by a pivot connection (38b).

7. The mechanism of claim 1 further comprising an actuator operable to vary the resistive force generated by the brake assembly.

8. The mechanism of claim 1 wherein the resistive force is applied about the pivot axis of the linkage.

9. A door check mechanism for a door of a vehicle, comprising:
a biasing member in operable connection with a linkage coupling the door to a vehicle body;
a rotatable brake assembly coupled to the linkage, wherein a movement of the linkage causes a rotation of the rotatable brake assembly; and
an actuator for controlling a biasing state of the biasing member, wherein a change in the biasing state of the biasing member varies a friction force applied by the rotatable brake assembly to the linkage for resisting the movement of the door.

10. The door check mechanism of claim 9, wherein the linkage is part of a multibar linkage assembly (82).

11. The door check mechanism of claim 9, wherein the linkage is configured to pivot about an axis (48), such that the axis is one of the pivots of the multibar linkage assembly (82).

12. The mechanism of claim 9, wherein the rotatable brake assembly further comprises a friction body and the biasing member positioned adjacent to the friction body, such that contact between a first surface of the friction body and a second surface of the biasing member generates the friction force to provide for said resisting the movement of the door.

13. The mechanism of claim 9, wherein said varies the friction force is performed by either increasing or decreasing a diameter of the biasing member.

14. A door check mechanism for a door of a vehicle comprising:
a linkage coupled between a vehicle body and the door, the linkage configured to pivot about an axis;
an actuator; and
a brake assembly coupled to one of the door and the vehicle body, the brake assembly comprising a roller arrangement (64) for applying variable resistive force to the linkage to resist movement of the door relative to the vehicle body;
wherein the roller arrangement is operable by operation of the actuator.

15. The door check mechanism of claim 14, wherein the roller arrangement includes a roller selected from the group consisting of: a ball and a cam.

16. The mechanism of claim 14, wherein the brake assembly further comprises a friction body and a biasing member positioned adjacent to the friction body, such that contact between a first surface of the friction body and a second surface of the biasing member generates friction of the resistive force to provide for said resist movement of the door.

17. The mechanism of claim 16 further comprising a member guide coupled to the biasing member and to an adjustment actuator, such that operation of the adjustment actuator displaces the member guide relative to the biasing member in order to vary the friction generated between the first surface and the second surface.

18. The mechanism of claim 17, wherein the displacement of the member guide either increases or decreases a diameter of the biasing member.

19. The mechanism of claim 15 further comprising an adjustment actuator operable to vary the variable resistive force generated by the brake assembly.

20. The mechanism of claim 14 wherein the variable resistive force is applied about the axis of the linkage.
